(19) United States
(12) Patent Application Publication
(10) Pub. No.: US 2015/0375870 A1
(43) Pub. Date: Dec. 31, 2015

(54) METHOD FOR TESTING A MAINTENANCE AND MATERIALS MANAGEMENT SYSTEM

(71) Applicant: The Boeing Company, Chicago, IL (US)

(72) Inventors: Clarence E. Poisson, JR., Federal Way, WA (US); Eric D. Elavia, Kent, WA (US)

(21) Appl. No.: 14/843,192

(22) Filed: Sep. 2, 2015

Related U.S. Application Data
(62) Division of application No. 11/623,474, filed on Jan. 16, 2007.
(60) Provisional application No. 60/882,770, filed on Dec. 29, 2006.

(51) Int. Cl. B64D 45/00; G07C 5/08; G07C 5/00

(52) U.S. Cl. CPC B64D 45/00; G07C 5/006; G07C 5/008; G07C 5/085; G07C 5/0808; B64D 2045/0085

(57) ABSTRACT

A method for testing an airplane maintenance system, which comprises the steps of: testing communications and data transmission between an aircraft operator and a management service provider; testing general communications and data transmission between internal systems of the management service provider; and testing communications and data transmission between the internal systems of the management service provider during for predetermined procedures.

### CROSS-REFERENCE TO RELATED APPLICATIONS

This application is a divisional of U.S. application Ser. No. 11/623,474 filed on Jan. 16, 2007 which claims priority to U.S. Provisional Application Nos. 60/882,770, filed on Dec. 29, 2006. The entire disclosures of U.S. application Ser. No. 11/623,474 and U.S. Provisional Application No. 60/882,770 are hereby incorporated herein by reference.

### FIELD OF THE INVENTION

This invention generally relates to a method for testing a centrally managed, integrated maintenance and materials management system and more particularly to one that provides turnkey maintenance for multiple fleets of aircraft.

### BACKGROUND

Maintenance of commercial aircraft fleets requires the coordination of multiple service and information providers, as well as part suppliers. Line and base maintenance operations required to support aircraft flight readiness require up-to-date service manuals, maintenance repair records, engineering drawings, trained personnel, specialized tools, facilities, parts and an array of other resources. The logistics required for deploying, warehousing and maintaining inventories of repair parts at multiple service locations is also complicated, since parts must be procured from multiple suppliers as well the OEM aircraft manufacturers. Supply chain management and coordination of service providers is made more challenging where fleet aircraft serve wide geographic areas, making centralized service and inventory control by the airline operators impractical.

While some minor maintenance, e.g. line maintenance, is performed by certain airline operators, most operators either perform their own extensive maintenance (typically performed at base maintenance facilities) or outsource their maintenance by contracting with MROs (maintenance, repair and overhaul organizations). The airline operators nevertheless remain largely responsible for managing the material supply chain, performing service operations, coordinating ground service equipment, and managing information flow, including compliance with regulatory and maintenance certification requirements such as Air Worthiness Directives (ADs). Consequently, multiple commercial airlines must dedicate identical resources for maintaining the internal infrastructure and personnel needed to manage the various service and material management activities outlined above.

To address the above concern, centralized, integrated maintenance and materials management systems have been developed, which overcome the deficiencies of the prior art discussed above, such as that described and claimed in U.S. patent application Ser. No. 11/281,279 filed Nov. 16, 2005, entitled “Centralized Management of Maintenance and Materials for Commercial Aircraft Fleets”, which is incorporated by reference herein for all purposes. One current issue with these systems is that currently there is not way to test the systems to verify that they are working properly.

Therefore, there is a need for a method to test centralized, integrated maintenance and materials management systems, such as by testing their data exchanges, logic, processes, and functionality, to verify that the systems are working properly.

### SUMMARY OF THE INVENTION

The present invention relates to a method for testing an airplane maintenance system, which comprises the steps of: testing communications and data transmission between an aircraft operator and a management service provider; testing general communications and data transmission between internal systems of the management service provider; and testing communications and data transmission between the internal systems of the management service provider during for predetermined procedures.

### BRIEF DESCRIPTION OF THE DRAWINGS

FIG. 1 is a block diagram showing an example of the organization of an integrated maintenance and materials management system.

FIG. 2 is a block diagram showing an example of the primary functional elements of the system shown in FIG. 1.

FIG. 3 is a block diagram showing an example of the functional elements of the integrated materials management and the maintenance services in relation to a central operations center.

FIG. 4 is a block diagram showing an example of the organizational relationship between the aircraft owners/operator, MROs, parts suppliers and the central operations center.

FIG. 5 is a combined block and diagrammatic view showing an example of additional details of the integrated materials management and maintenance system, including aircraft on-board systems, and depicting the transformation of data into information, and the sharing of this information between the MSP, the suppliers and the MROs.

FIG. 6 is a block diagram showing an example of the flow of data and information in the integrated materials management and maintenance system.

FIG. 7 is a block diagram showing an example of how aircraft configuration data is gathered and used in the integrated materials management system.

FIG. 8 is a combined block and diagrammatic view showing an example of how on-board aircraft data is gathered and stored as centralized information.

FIG. 9 is a flow diagram showing exemplary steps for the overall testing of a maintenance and materials service system.

FIG. 10 is a flow diagram showing exemplary steps for testing the communications and data transmission between an aircraft owner/operator and an MSP.

FIG. 11 is a flow diagram showing exemplary steps for testing the communications and data transmission between an MEM server and an ISDP server.

FIG. 12 is a flow diagram showing exemplary steps for testing the communications and data transmission between an MEM server and an IMM server.

FIG. 13 is a flow diagram showing exemplary steps for testing the communications and data transmission between an MEM server and a SA server.

FIG. 14 is a flow diagram showing exemplary steps for testing the communications and data transmission between an MEM server and an ELBg server.

FIG. 15 is a flow diagram showing exemplary steps for testing the communications and data transmission between internal systems of an MSP during non-routine maintenance procedures.

FIG. 16 is a flow diagram showing exemplary steps for testing the communications and data transmission between internal systems of an MSP during routine maintenance procedures.

FIG. 17 is a flow diagram showing exemplary steps for testing the communications and data transmission between internal systems of an MSP during servicing procedures.

FIG. 18 is a flow diagram showing exemplary steps for testing the communications and data transmission between internal systems of an MSP during material/tool request procedures.

### DETAILED DESCRIPTION

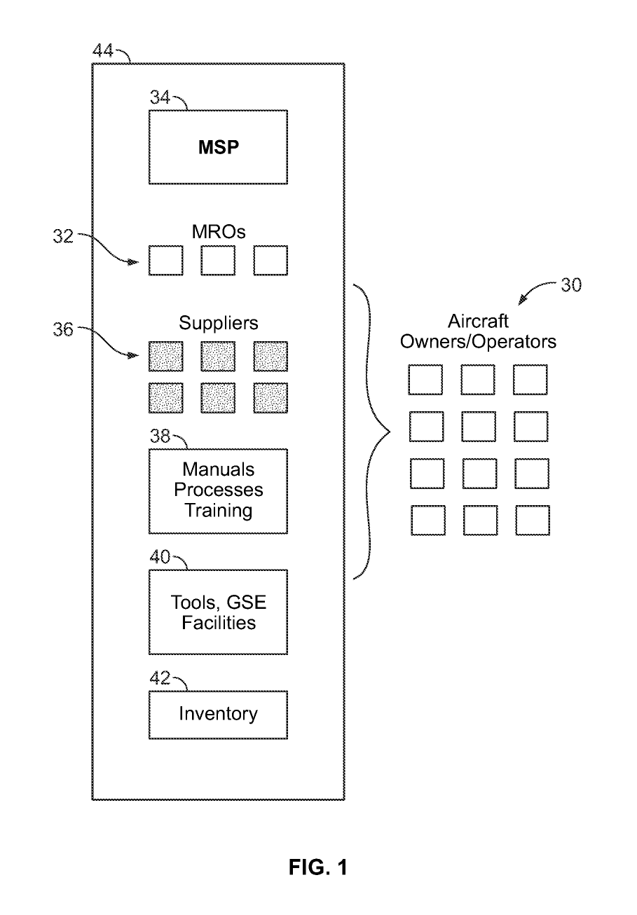

FIG. 1 shows an example of a centrally managed, integrated maintenance and materials service system (IMMS) 44. The IMMS 44 is managed by a single management service provider (MSP) 34, sometimes also referred to herein as an integrator, which may be, for example, the aircraft original equipment manufacturer (OEM). As will be discussed later in more detail, the MSP 34 has responsibility for managing the maintenance, repair and overhaul organizations (MROs) 32 and suppliers 36, as well as managing the necessary manuals, training 38, tooling, ground support equipment (GSE), and facilities 40, and parts inventory 42. The MROs 32 may provide major maintenance services at so-called base maintenance locations or in some cases may also provide minor maintenance services at so-called line maintenance locations or facilities.

The MSP 34 provides the IMMS 44 to aircraft owners/operators 30, essentially as a turn-key service, relieving the aircraft owners/operators 30 of the need for managing MROs, parts inventory, etc. Optionally, the MSP 34 may provide the aircraft owners/operators 30 with only centrally managed maintenance, or centrally managed, integrated materials management (IMM).

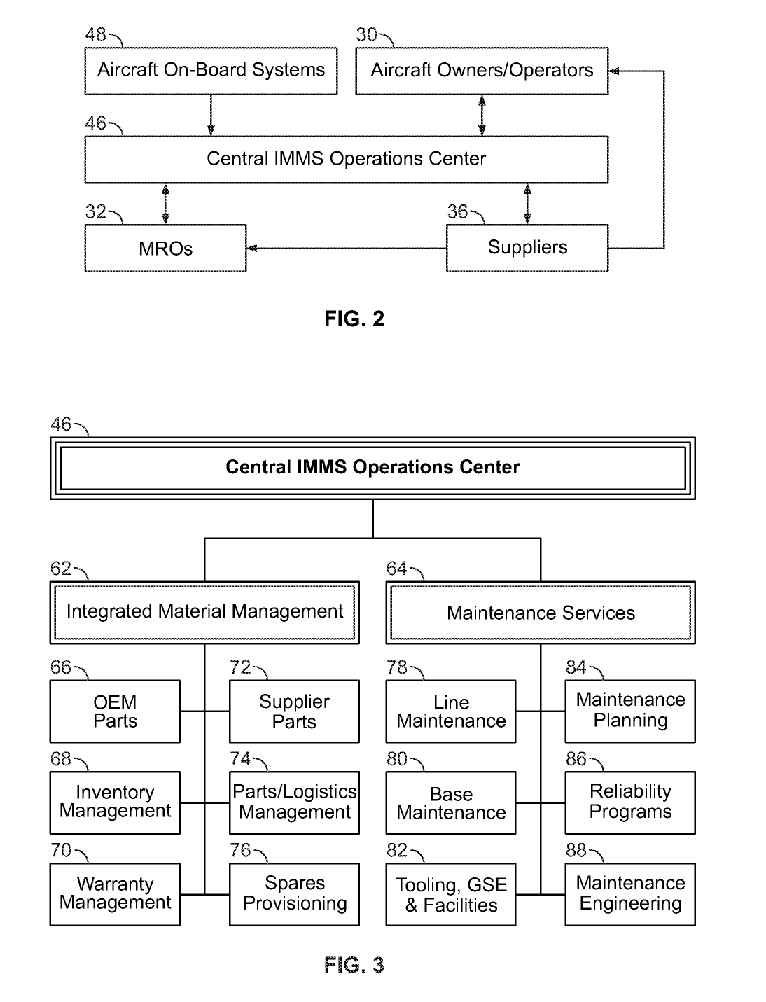

FIG. 2 shows an example of the overall functional relationship between the MROs 32, suppliers 36, customers and central management of maintenance functions provided by the MSP 34. The MSP 34 controls a central IMMS operations center 46. The operations center 46 receives various kinds of data from aircraft onboard systems 48 and converts this data into centrally stored information which is used in the management of the IMMS 44. As will be discussed later in more detail, this onboard systems data may include for example, flight log records, data from a flight record recorder, aircraft health management, and aircraft configuration information.

Information is exchanged between the operations center 46 and the aircraft owners/operators 30. For example, information is obtained from the aircraft owners/operators 30 relating to performance of the aircraft, departure and arrival information, reliability data, etc. The information from the on-board systems 48 and the aircraft owners/operators 30 is used for a variety of purposes at the operation center 46, including scheduling and ordering of parts, scheduling and ordering of maintenance operations and determining aircraft utilization that is converted into the price charged to the aircraft owners/operators 30 for the services rendered by the MSP 34.

Information is also exchanged between the MROs 32 and the operation center 46 that facilitates scheduling and coordination of base and/or line maintenance for the aircraft. Finally, information is exchanged between the operation center 46 and suppliers 36, which are managed directly under the IMMS 44 by the MSP 34.

Referring now to FIG. 3, the exemplary integrated material management 62 and maintenance services 64 are controlled and managed by the central IMMS operations center 46 using information about the aircraft obtained from the aircraft on-board systems 48, which will be discussed later in more detail. The operations center 46 may provide maintenance services 64 or integrated material management 62, or both. As used herein, integrated maintenance and material services, or IMMS, means a service program that combines and integrates both maintenance services 64 and IMM 62.

As will be discussed later in more detail, IMM 62 includes management by MSP 34 of OEM parts 66, supplier parts 72, parts inventory management 68, management of parts/logistics 74, warranty management 70, and spare part provisioning 76.

The maintenance services 64 include line maintenance 78, base maintenance 80, management of tooling, GSE, and facilities 82, maintenance planning 84, management of reliability programs 86, and maintenance engineering 88.

In the case where MSP 34 provides aircraft owners/operators 30 with only IMM 62 as a standard service, MSP 34 assumes responsibility for procuring the parts, which MSP 34 then deploys to aircraft owners/operators 30 or MROs 32. MSP 34 retains ownership (legal title) of the parts, but aircraft owners/operators 30 take responsibility for warehousing the parts inventory. As will be later discussed, a server is maintained onsite at the parts warehouse which is networked with the operations center 46.

In this example, when aircraft owners/operators 30 remove a part from the warehouse for use in servicing an aircraft, the removal of the part from inventory is electronically communicated through the onsite warehouse server to operations center 46, thus allowing MSP 34 to maintain real time records of the part inventory at the warehouse. This real time information is used by MSP 34 to allow timely reordering of replacement parts, and just-in-time delivery to the warehouse in order to maintain part inventories at optimum levels. When operations center 46 receives notice that a part has been removed from the warehouse inventory, ownership immediately passes to aircraft owners/operators 30, which are invoiced for the part. This business model allows MSP 34 to accumulate historical information concerning the type and number of parts used by aircraft owners/operators 30 at multiple warehouse locations, which aids MSP 34 in efficiently managing part inventory levels and the logistics of part delivery. Moreover, this accumulated information concerning the parts used aids MSP 34 in providing data to pricing model used to charge for the services provided by MSP 34.

The IMM program described above allows MSP 34 to purchase parts based on a customer's forecasted consumption. As a result, it is generally necessary to carry lower levels of inventory, and fewer parts are required to be written off to obsolescence. Moreover, the IMM parts management program facilitates balancing and pooling of part inventories at differing customer warehouse locations.

In contrast to the IMM program utilized as a stand alone service, the management and deployment of parts is handled in a different manner when MSP 34 provides aircraft owners/operators 30 with IMMS, as will be discussed below in more detail. Briefly, aircraft owners/operators 30 are not required to warehouse most parts under the IMMS program since the parts sourced either from MSP 34 or suppliers 36 are supplied directly to MROs 32 in connection with the maintenance provided by MROs 32.

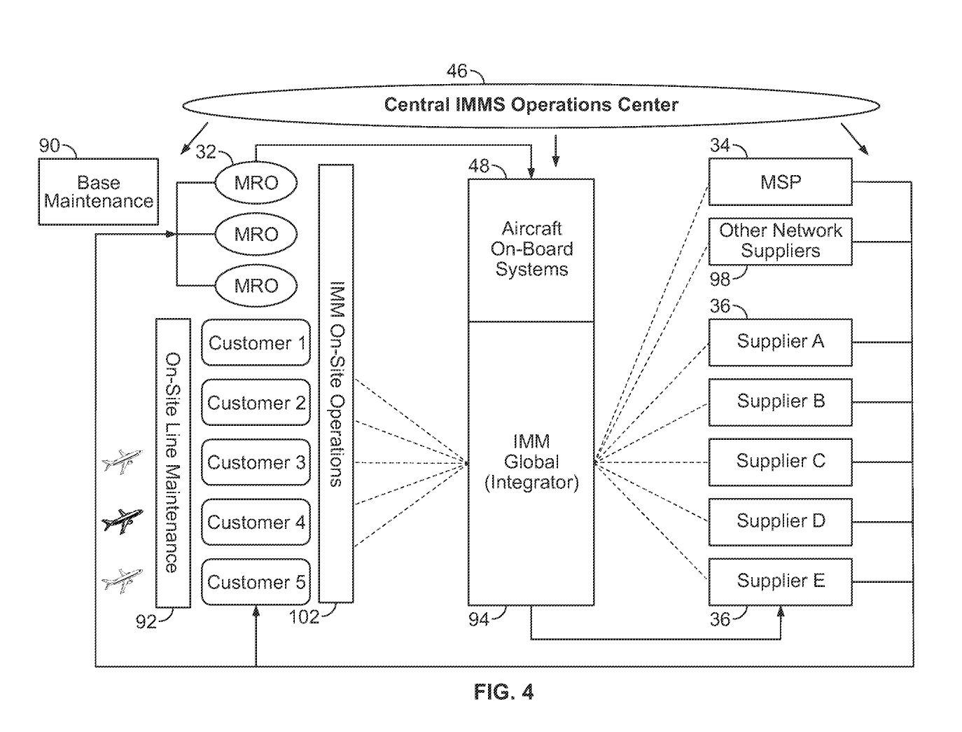

Referring to FIG. 4, it is shown in greater detail how the exemplary IMMS provided to aircraft owners/operators 30 (shown as customers 1-5) is managed by MSP 34 using operations center 46. MSP 34 contracts with and manages MROs 32 who provide onsite line maintenance 92, generally at locations where aircraft owners/operators 30 fly. MROs 32 also provide aircraft owners/operators 30 with base maintenance, coordinated by operations center 46. In instances where unplanned maintenance is required, based on on-board systems 48, operations center 46 acts as a global integrator of the parts, engineering, services, and maintenance tasks to perform the necessary work to remedy the fault. In IMMS, however, operation center 46 manages the entire materials supply chain, ordering parts directly from MSP 34, network suppliers 98 and various other suppliers 36, and arrange for their delivery to MROs 32.

In one possible business model, MSP 34 pays suppliers 36, 98 based on aircraft flight hours, or where the parts involve expendables, the charges are based on consumption. Operations center 46 manages deployment of the parts either directly to aircraft owners/operators 30 (where maintenance service is not provided by MSP 34), or to MROs 32 (where IMMS is provided). In either event, MSP 34 provides up to 100% of the part requirements which are managed by MSP 34 until the exchanged part is installed on the aircraft. Under IMMS, MSP 34 provides a guaranteed level of service to aircraft owners/operators 30, and as can be appreciated from FIG. 4, operations center 46 managed by MSP 34 acts as a single point of management and invoicing for the entire materials supply chain.

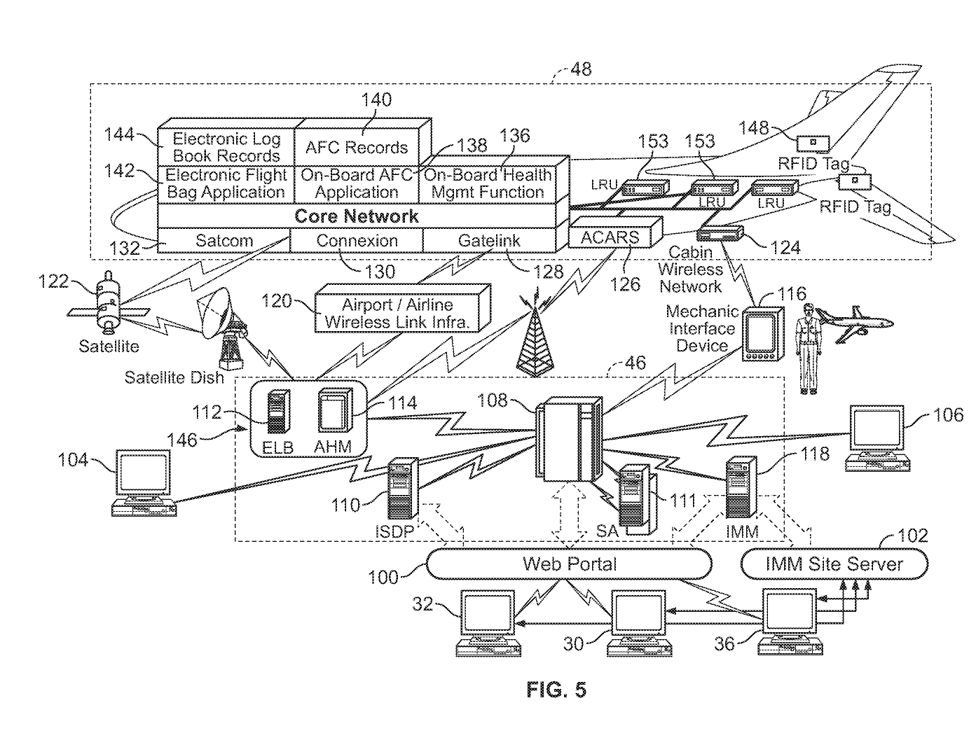

Reference is now made to FIG. 5, which shows exemplary details of the architecture of the IMMS program for aircraft fleets. Broadly, a number of onboard data gathering systems 48 gather and download aircraft data through, for example, wireless links, broadband, narrowband or other suitable communications systems to operations center 46, where the data is converted to information that is stored and used to manage the IMMS program. It is also possible to download the data through hard communication connections when the aircraft is on the ground. In one example, MROs 32, aircraft owners/operators 30, and suppliers 36 are connected to operation center 46 through a suitable communication link, such as for example, an interne web portal 100.

The onboard data systems 48 include a variety of devices and record management systems interconnected through an onboard data bus. A core network of applications connected with the data bus includes, for example, electronic log book (ELB) records 144, an electronic flight bag application 142, flying configuration records 140, an onboard as flying configuration application 138, and an onboard health management function (OHMF) application 136. The electronic flight bag application 142 provides the aircraft pilot with electronic charts, aircraft performance calculations, electronic documents, fault finders, and electronic check lists. The electronic log book record 144 includes information related to aircraft faults that have been recorded onboard or entered manually by the crew or aircraft personnel. The as flying configuration application 138 and AFC records 140 provide information concerning the current configuration of the aircraft. The onboard health management function 136 comprises aircraft system monitoring functions that relay, in real time, the current status of the aircraft systems which can be used to make repairs after the aircraft lands. Line replaceable units (LRUs) 153 as well as radio frequency identification (RFID) tags 148 provide information concerning other onboard components used to determine the as-flying configuration of the aircraft.

U.S. patent application Ser. No. 11/173,806, filed Jun. 30, 2005, entitled “Integrated Device for Configuration Management” shows how RFID tags may be used to track aircraft configuration is incorporated herein by reference for all purposes. U.S. Patent Application No. 60/718,884, filed Sep. 20, 2005, entitled “RFID Tags on Aircraft Parts” and U.S. patent application Ser. No. 10/973,856, filed Oct. 25, 2004, entitled “Reducing Electromagnetic Interference in Radio Frequency Identification Applications” also show use of RFID technology useful to implementing the present invention and are also incorporated herein by reference for all purposes.

The data provided by the onboard systems 48 could be wirelessly communicated by any of a variety of communication links including satellite 122 forming part of SATCOM 132, a proprietary wireless internet connection such as Connexion^{SM} 130 provided by the Boeing Company, wireless link 128 and associated terminal wireless infrastructure 120, aircraft communication addressing and reporting systems (ACARS) 126, as well as cabin wireless networks 124, which communicate to operation center 46 through interface devices 116 typically used by aircraft mechanics Some examples of systems suitable for use in wirelessly transmitting the data are disclosed in US Patent Application No. US 2005/0026609 A1, published Feb. 3, 2005, and US Patent Application Publication No. US 2003/0003872 A1, published Jan. 2, 2003, which are incorporated herein by reference for all purposes.

Additional onboard systems suitable for use with the present invention are disclosed in co-pending applications, for example: U.S. patent application Ser. No. 10/976,662, filed Oct. 27, 2004, entitled “Wireless Airport Maintenance Access Point”; U.S. patent application Ser. No: 11/191,645, filed Jul. 28, 2005, entitled “Airborne Electronic Logbook Instances and Ground Based Data System”; U.S. patent application Ser. No. 11/176,831, filed Jul. 7, 2005, entitled “Distributed Data Load Management System Using Wireless Satellite or ACARS”; and U.S. patent application Ser. No. 11/199,399, filed Aug. 8, 2005, entitled: “Methods for Fault Data Transfer from Airplane Central Maintenance Systems to Electronic Flight Bag Systems and Electronic Logbook (ELB) Application”, which are incorporated herein by reference for all purposes.

Wireless link 128 is a system that utilizes wireless local area network technology to transmit data throughout an airport environment enabling instant sharing of data between aircraft, passenger terminals, maintenance operations, etc. In one example, onboard data is uploaded to server site 146, which includes ELB server 112 and AHM server 114 that are in turn connected through a network with central maintenance and engineering management (MEM) server 108 at operations center 46. Also included at operations center 46 is in-service data program (ISDP) server 110, situational awareness (SA) server 11, and IMM server 118, all of which are connected by a network to MEM server 108. Supplier management terminal 106 is connected with MEM server 108 to allow communication with suppliers, while finance business management terminal 104 is connected with MEM server 108 to allow management of financial issues. IMM server 118 is connected to MROs 32 and aircraft owners/operators 30 via web portal 100 and is connected with suppliers 36 via IMM site server 102.

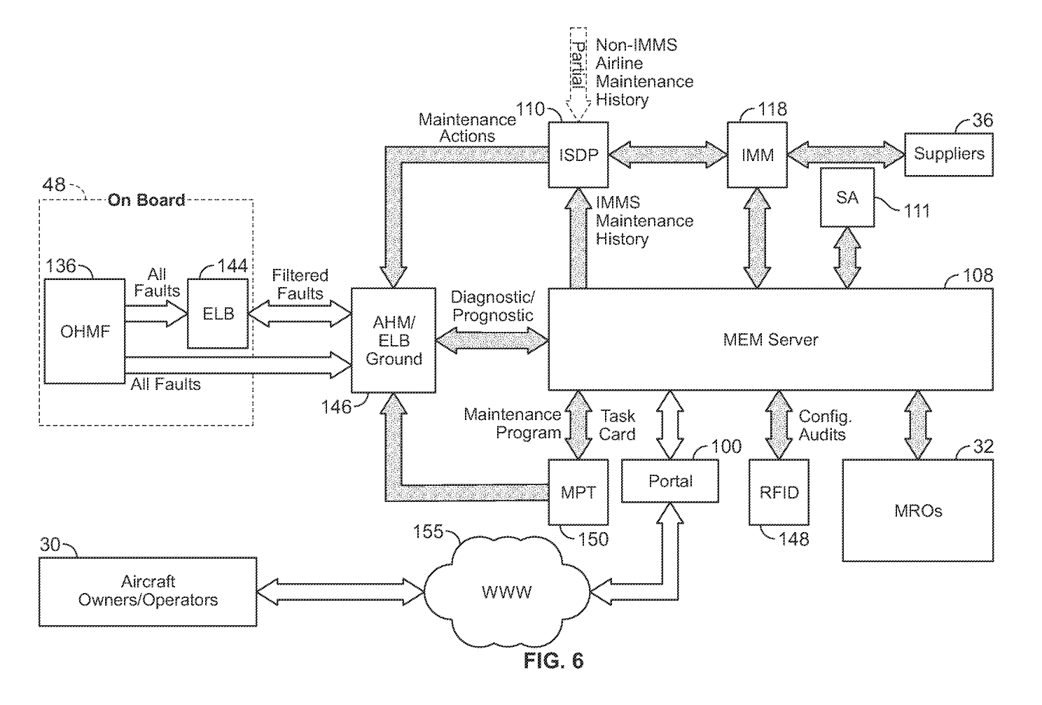

FIG. 6 shows, in block diagram form, an example of the flow of information and data between onboard systems 48, MEM server 108, suppliers 36, and MROs 32. In one example, all faults registered by the OHMF application 136 are logged in the ELB records 144, filtered, and delivered to a ground based server (ELBg) 146, which collects these faults, as well as unfiltered faults directly from the OHMF application 136. ELBg 146 also communicates with MEM server 108. Other techniques are also possible for delivering the faults to MEM server 108. Both IMMS and non-IMMS airline maintenance history is provided to in-service data program (ISDP) server 110, which also exchanges information with IMM server 118.

A maintenance performance tool box (MPT) 150 exchanges information with MEM server 108 and ELBg server 146. MPT 150 uses intelligent documents and visual navigation methods to assist technical operations staff to troubleshoot aircraft systems and manage structural repair records, parts, and task cards. MPT 150 also provides 3D models for recording, reviewing, and analyzing structural repairs, making use of accumulated repair knowledge and maintaining records of repair activities for one or more aircraft. MPT 150 also acts as the repository for historical maintenance records for each aircraft which are required to be maintained by regulatory authorities. MEM server 108 uses the data it receives to diagnose on board problems and form a prognosis for those problems. As can be more easily seen in FIG. 6, the aircraft owners/operators 30 have access to an array of information and tools resident in operations center 46 using the World Wide Web 155 to access the portal 100.

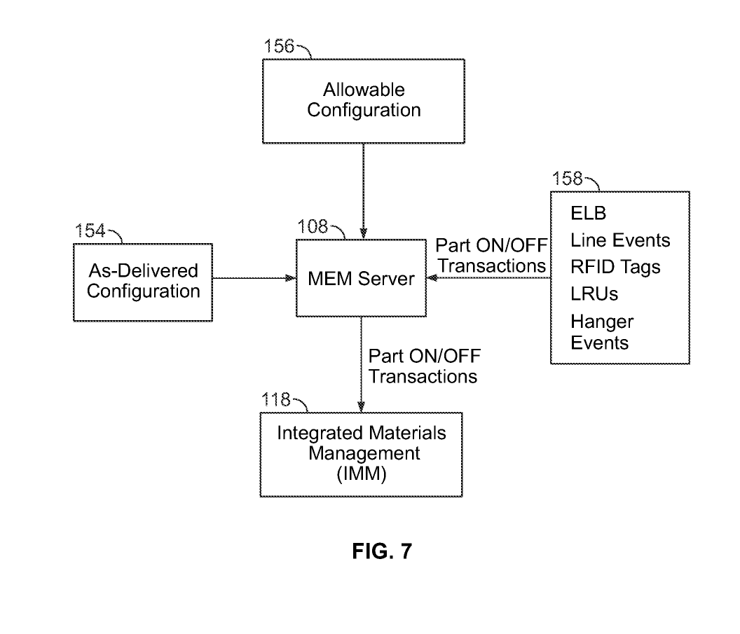

One part of the IMMS system resides in the ability to determine the current configuration of aircraft, since parts and functional units are added, replaced, or deleted on a routine basis. As shown in FIG. 7, MEM server 108 maintains a record of the current as-flying configuration which is used to manage both maintenance and materials for the aircraft. The as-delivered configuration data 154, which defines the configuration of the aircraft as initially delivered to the customer, and information concerning the allowable configuration 156 is provided to and stored in MEM server 108. Part on/off transactions derived from a variety of information sources 158 are also provided to MEM server 108 and these transactions, as well as the as-flying configuration, are delivered to IMM server 118 to be used in the management of materials. The part on/off transactions are recorded by devices such as the electronic log book 144, line events, RFID tags 148, LRUs 153, and hangar events, as shown at 158.

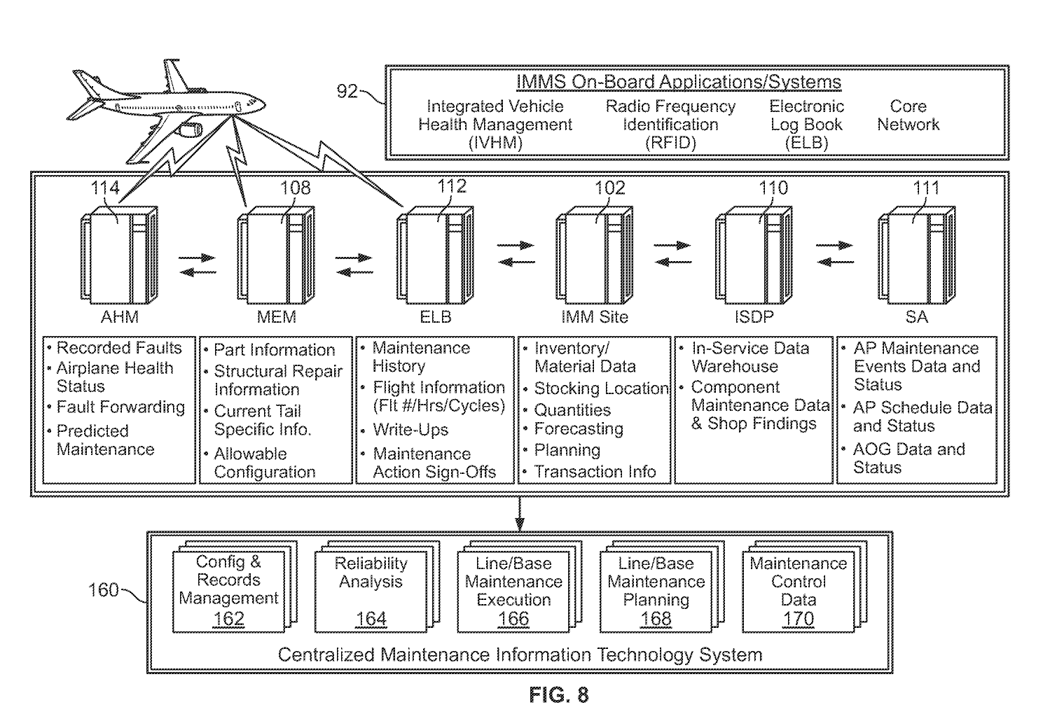

Referring now to FIG. 8, one example of the organization of information stored at operations center 46, based on data derived from on-board applications and systems 48, is shown. AHM server 114 can store recorded faults, airplane health status, fault forwarding information, and predicted maintenance information, while ELB server 112 can store maintenance history, flight information in teems of the flight number hours and cycles of the aircraft, write-ups by the pilots, and maintenance action sign offs.

MEM server 108 can store part information, information concerning structural repairs, current detailed specific information, and allowable configuration information relating to the aircraft. IMM site server 102 can store inventory and material data, stocking location information, part quantity information, forecasting information, planning information and transaction information. ISDP server 110 can store in-service data warehouse information and component maintenance data, as well as shop findings. Finally, SA server 111 can store AP maintenance events data and status, AP schedule data and status, and airplane on ground (AOG) data and status. Servers 102, 108, 110, 11, 112, and 114 are connected in a common network or through the Internet so that all of the stored data can be transmitted and shared in real time by the servers and used by MSP 34 to manage the IMMS system 44. Other forms of information storage devices and communications links between them are also possible.

The information collectively stored in servers 102, 108, 110, 111, 112, and 114 is organized to form a centralized maintenance information technology system 160, although these servers need not be in the same physical location. Electronic storage devices other than servers may also be utilized. This information is arranged to facilitate management of various functions required by the IMMS system 44, including configuration and records management 162, reliability analysis 164, line/base maintenance execution 166, line/base maintenance planning 168, and maintenance control data 170.

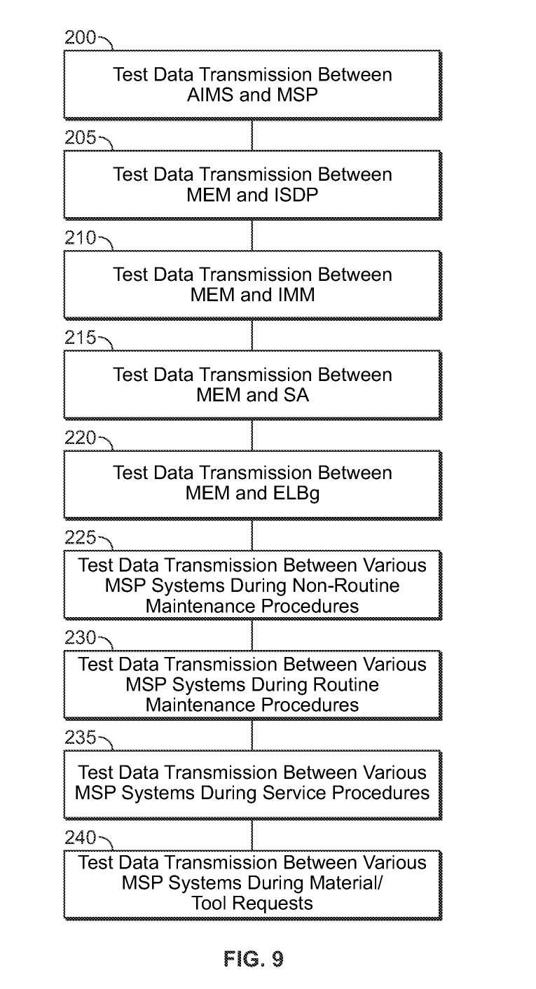

Referring now to FIGS. 9-18, flow diagrams representing one example of a recordable method to test IMMS 44, specifically the data exchanges, logic, processes, and functionality of IMMS 44, is shown.

Referring specifically to FIG. 9, exemplary steps taken to test a maintenance and materials service system are shown. At step 200, the communications and data transmission between aircraft owners/operators 30, for example an airline information system (AIMS) operated by an aircraft owner/operator, and various systems of MSP 34 are tested. At step 205, the communications and data transmission between MEM server 108 and ISDP server 110 are tested. At step 210, the communications and data transmission between MEM server 108 and IMM server 118 are tested. At step 215, the communications and data transmission between MEM server 108 and situational awareness (SA) server 111 are tested. At step 220, the communications and data transmission between MEM server 108 and ELBg server 146 are tested. At step 225, communications and data transmission between internal systems of the management service provider during non-routine maintenance procedures are tested. At step 230, communications and data transmission between internal systems of the management service provider during routine maintenance procedures are tested. At step 235, communications and data transmission between internal systems of the management service provider during service procedures are tested. At step 240, communications and data transmission between internal systems of the management service provider during material/tool request procedures are tested. As will be described in more detail below, each of the above steps 200-240 consist of testing communications, testing data transfer, and verifying that the data received and recorded by various systems is correct and the results of each of the test is recorded.

Steps 205-220 above, represent the testing of communications and data transmission in general between various internal systems of MSP 34, while steps 225-240 represent the testing of communications and data transmissions between various internal systems of MSP 34 during specific procedures that are carried out by MSP 34. By executing the steps 200-240, the process flow of a typical airplane maintenance system is simulated and tested. Breaking down the testing into individual tests provides added convenience by allowing the testing to be performed at various times and by various individuals, rather than having to test the entire IMMS 44 at one time.

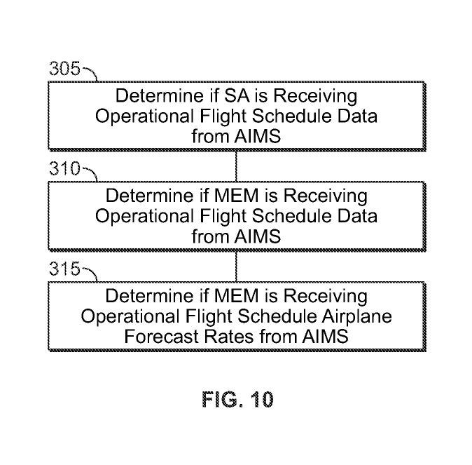

Referring now to FIG. 10, exemplary steps taken to test the communications and data transmission between aircraft owners/operators 30 and various internal systems of MSP 34 (step 200 above) are shown. At step 305, it is determined if SA server 111 of MSP 34 is communicating with and receiving operational flight schedule data records from the AIMS of aircraft owners/operators 30 and if SA server 111 is recording the proper data records. Operational flight schedule data records are created by aircraft owners/operators based on a master flight schedule.

At step 310, it is determined if MEM server 108 of MSP 34 is communicating with and receiving operational flight schedule data records from the AIMS of aircraft owners/operators 30 and if MEM server 108 is recording the proper data records. As part of this test, it is determined if MEM server 108 is receiving and recording new data records, updates to existing data records, cancellations of data records, and diversions of flights for which there are data records. For example, if an airline owner/operator 30 creates a new operational flight schedule data record, it is verified that MEM server 108 is receiving and properly recording this new data record. If an airline owner/operator 30 updates an existing operational flight schedule data record, it is verified that MEM server 108 is receiving and properly recording the update. If an airline owner/operator 30 cancels an existing operational flight schedule data record, it is verified that MEM server 108 is receiving and properly recording the cancellation. If an airline owner/operator 30 updates an operational flight schedule data records because it diverts a flight, for example for inclement weather at the flight's original destination, it is verified that MEM server 108 is receiving and properly recording the diversion notification.

At step 315, it is determined if MEM server 108 is receiving operational flight schedule airplane forecast rates from the AIMS of aircraft owners/operators 30 and if MEM server 108 is recording the proper operational flight schedule airplane forecast rates. Operational flight schedule airplane forecast rates are manually entered into the AIMS by aircraft owners/operators 30.

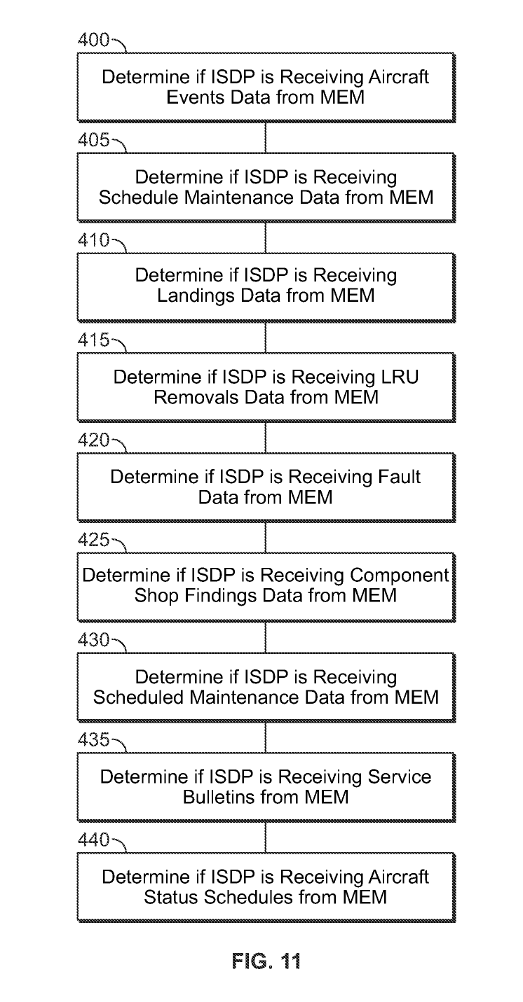

Referring to FIG. 11, exemplary steps taken to test the communications and data transmission between MEM server 108 and ISDP server 110 (step 205 above) are shown. At step 400 it is determined if ISDP server 110 of MSP 34 is receiving aircraft events data from MEM server 108 of MSP 34 and if ISDP server 110 is recording the proper data. As used herein, aircraft events are events that are different from the flight as scheduled. For example, aircraft events could be a delay indicator, a cancellation indicator, a diversion indicator, an air turn back indicator, a general air interrupt indicator, an aborted takeoff indicator, a speed of aborted/rejected take off, a return to gate indicator, a general ground interrupt indicator, a delay time, an aborted approach indicator, an emergency descent indicator, an in-flight shutdown indicator, a substitute aircraft indicator, a service interrupt chargeability indicator, a suspected maintenance error indicator, a suspected operational error indicator, a technical incident indicator, a reliability exchange of airline data international (READI) execution indicator, an incident cause code, or a consequential incident code.

At step 405, it is determined if ISDP server 110 is receiving schedule maintenance data records from MEM server 108 and if ISDP server 110 is recording the proper data records. As used herein, schedule maintenance data is the data associated with a bill of work, such as the bill of work's tasks under a work order.

At step 410, it is determined if ISDP server 110 is receiving landings data records from MEM server 108 and if ISDP server 110 is recording the proper data records. As used herein, landings data refers to flight hours for every flight leg and the associated cycles for that flight leg., A flight leg is the airplane's starting point to the next destination. A cycle is one flight leg's OOOI.

At step 415, it is determined if ISDP server 110 is receiving LRU removals data records from MEM server 108 and if ISDP server 110 is recording the proper data records. LRU removal data records contain information as to when a LRU has been removed from a particular aircraft.

At step 420, it is determined if ISDP server 110 is receiving fault data records from MEM server 108 and if ISDP server 110 is recording the proper data records. Fault data records contain information as to faults that were noted by the automated aircraft systems, by pilots, by maintenance crews, etc. for a particular aircraft. For example, if a pilot noted that during a flight a warning light was illuminated, but no problem was found, this fault would be recorded in a fault data record.

At step 425, it is determined if ISDP server 110 is receiving component shop findings data records from MEM server 108 and if ISDP server 110 is recording the proper data records. Component shop findings data records contain information as to the findings of a component shop from their evaluation of a component from an aircraft. For example, if an LRU is removed from an aircraft and sent for evaluation and the evaluation finds that the component is operating within normal operating parameters, these results would be noted in a component shop findings data record.

At step 430, it is determined if ISDP server 110 is receiving scheduled maintenance data records from MEM server 108 and if ISDP server 110 is recording the proper data records. Scheduled maintenance data records contain information as the maintenance schedules for various aircraft.

At step 435, it is determined if ISDP server 100 is receiving service bulletin records from MEM server 108 and if ISDP server 110 is recording the proper records. Service bulletin records are typically generated by the Federal Aviation Administration (FAA) and contain information regarding service bulletins that the FAA issues for particular aircraft.

At step 440, it is determined if ISDP server 100 is receiving aircraft status change records from MEM server 108 and if ISDP server 110 is recording the proper records. One example of an aircraft status change would be an airplane status changes from serviceable or flight worthy to unserviceable or un-flight worthy. As part of this test, it is determined if ISDP server 110 is receiving and recording: new aircraft status change records; updates to existing aircraft status change records; notification of diversions of flights; and notifications when one aircraft is swapped for another aircraft for a particular flight.

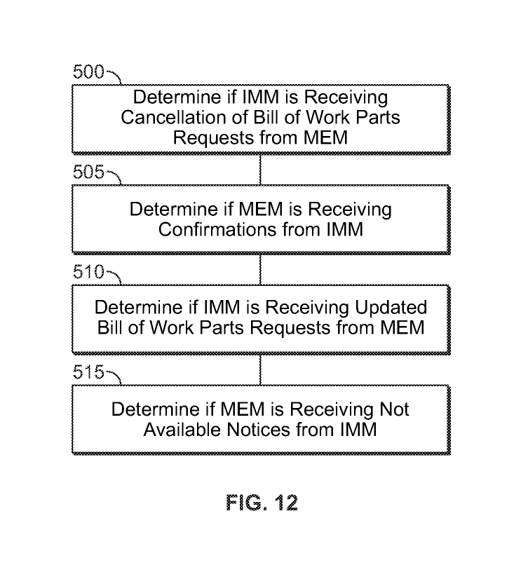

Referring to FIG. 12, exemplary steps taken to test the communications and data transmission between MEM server 108 and IMM server 118 (step 210 above) are shown. In one example, if an aircraft owner/operator 30 were to revise the operational flight schedule data, this revision may impact one or more bills of work that have been scheduled for a particular aircraft. If a bill or work is impacted, the bill of work must be revised and a determination must be made if the revision of the bill of work will require a change in any part or tool reservations. If a part or tool reservation must be changed, MEM server 108 will send a cancellation of bill of work parts request to IMM server 118 to cancel the current bill of work parts request. At step 500, it is determined if IMM server 118 of MSP 34 is receiving cancellation of bill of work parts requests from MEM server 108 of MSP 34 and if IMM server 118 is recording the proper data.

Once IMM server 118 receives a cancellation of bill of work parts request from MEM server 108, IMM server 118 will process the request and return a confirmation to MEM server 108 that the bill of work parts request has been cancelled. At step 505, it is determined if MEM server 108 is receiving confirmation of the cancellation of bill of work parts requests from IMM server 118.

Once MEM server 108 has received confirmation that the bill of work parts request has been cancelled it will send an updated bill of work parts requests to IMM server 118. At step 510, it is determined if IMM server 118 is receiving the updated bill of work parts requests from MEM server 108 and if IMM server 118 is recording the proper data.

Once IMM server 118 receives the updated bill of work parts request, a determination is made as to whether the requested part, tools, etc. is available on the requested date, at the requested time, at the requested location, etc. If the part or tool is not available, IMM server 188 sends a parts or tool not available notice to MEM server 108. At step 515, it is determined if MEM server 108 is receiving the parts or tool not available notices from IMM server 118 and if MEM server 108 is recording the proper data.

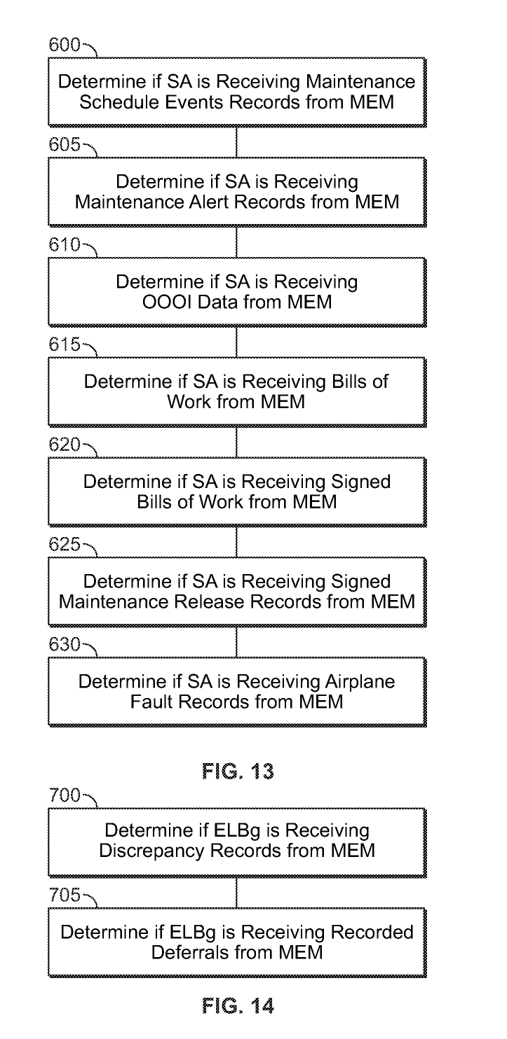

Referring to FIG. 13, exemplary steps taken to test the communications and data transmission between MEM server 108 and SA server 111 (step 215 above) are shown. At step 600, it is determined if SA server 111 is receiving maintenance schedule events records from MEM server 108 and if SA server 111 is recording the correct data. For example, a maintenance schedule event record could be a completed work order for scheduled maintenance. As part of this test, it is determined if SA server 111 is receiving and recording newly created maintenance schedule events records, updates to existing maintenance schedule events records, cancellations of maintenance schedule events records, and delays in planned maintenance schedule events records.

At step 605, it is determined if SA server 111 is receiving maintenance alert records from MEM server 108 and if SA server 111 is recording the correct data. As used herein, maintenance alerts are logic conditions set in MEM server 108 or a special code added to MEM server 108 to recognize MSP 34 defined alert conditions. For example, if a scheduled maintenance is scheduled to start at 3 pm, but doesn't start until 3:16 pm or later, this could be a trigger to alert MEM server 108 that the scheduled maintenance is late. The trigger logic would compare the start time to the start time plus 15 minutes to generate an alert trigger.

At step 610, it is determined if SA server 111 is receiving OOOI data records from MEM server 108 and if SA server 111 is recording the correct data. As used herein, OOOI data includes information for each flight such as: the time the aircraft door is closed at the gate (“Out time”); the time that the aircraft takes off (“Off time”); the time that the aircraft lands (“On time”); and the time that the aircraft reaches the gate (“In time”).

At step 615, it is determined if SA server 111 is receiving bills of work from MEM server 108 and if SA server 111 is recording the correct data. For example, once a bill of work has been created in MEM server 108, MEM server 108 sends the newly created bill of work to SA server 111, which records the bill of work and displays the bill of work as pending until completed.

At step 620, it is determined if SA server 111 is receiving bill of work signed records from MEM server 108 and if SA server 111 is recording the correct data. For example, once a bill of work has been completed, the bill of work must be signed in MEM server 108 indicating that all of the tasks listed in the bill of work have been completed. Once the bill of work has been signed, MEM server 108 then sends a copy of the signed bill of work to SA server 111. This step verifies that SA server 111 is receiving the signed bills of work and that SA server 111 is properly recording the data received.

At step 625, it is determined if SA server 111 is receiving signed maintenance release records from MEM server 108 and if SA server 111 is recording the correct data. For example, once all scheduled maintenance for an aircraft has been completed, a maintenance release must be signed in MEM server 108 indicating that all of the scheduled maintenance services have been completed. Once the maintenance release has been signed, MEM server 108 then sends a copy of the signed maintenance release to SA server 111.

At step 630, it is determined if SA server 111 is receiving airplane fault records from MEM server 108 and if SA server 111 is recording the proper data. Airplane fault records may include information as to faults that were noted by the automated aircraft systems, by pilots, by maintenance crews, etc. for a particular aircraft. For example, if a pilot noted that during a flight a warning light was illuminated, but no problem was found, this fault would be recorded in an airplane fault record.

Referring to FIG. 14, exemplary steps taken to test the communications and data transmission between MEM server 108 and ELBg server 146 (step 220 above) are shown. In one example, if an airplane discrepancy is found, such as during routine maintenance, the discrepancy is recorded in MEM server 108 of MSP 34, which will send a discrepancy message to ELBg server 146 of MSP 34. At step 700, it is determined if ELBg server 146 is receiving the discrepancy messages from MEM server 108 and if ELBg server 146 is recording the proper data.

Once the airplane discrepancy is recorded, a decision is made whether to fix the discrepancy or to defer fixing the discrepancy until a later date. If the decision is made to defer, approval for the deferral is obtained and the deferral is recorded in MEM server 108, which will send the recorded deferral to ELBg server 146. At step 705, it is determined if ELBg server 146 is receiving the recorded deferrals from MEM server 108 and if ELBg server 146 is recording the proper data.

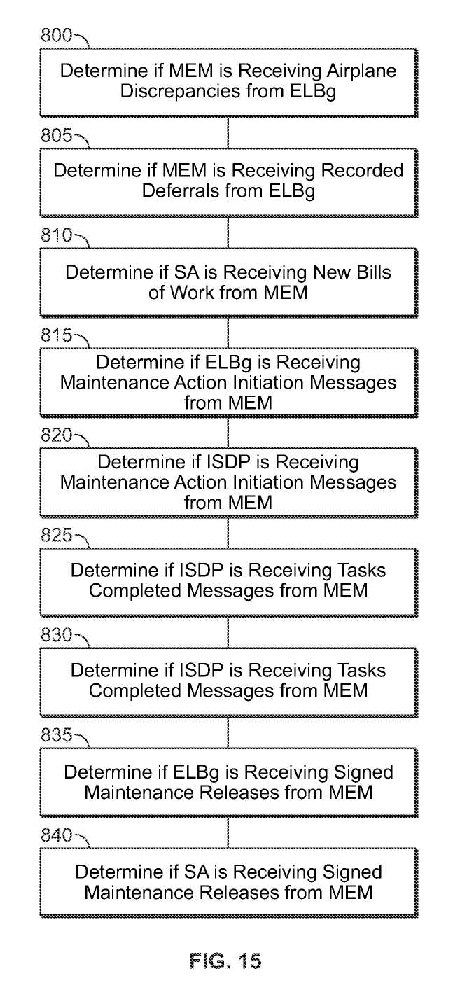

Referring to FIG. 15, exemplary steps taken to test the communications and data transmission between the internal systems of MSP 34 during non-routine maintenance procedures (step 225 above) are shown. In one example, if an airplane discrepancy is found in flight, the discrepancy is recorded in ELBg server 146, which will send a record of the airplane discrepancy to MEM server 108. At step 800, it is determined if MEM server 108 is receiving the airplane discrepancies from ELBg server 146 and if MEM server 108 is recording the proper data.

Once the discrepancy is recorded in ELBg server 146, the appropriate maintenance personnel are notified, and a decision is made whether to fix the discrepancy immediately or to defer fixing the discrepancy until a later date. If the decision is made to defer fixing the discrepancy until a later date, the deferral is in ELBg server 146, which will send the recorded deferral to MEM server 108. At step 805, it is determined if MEM server 108 is receiving the recorded deferrals from ELBg server 146 and if MEM server 108 is recording the proper data. If the decision is made to fix the discrepancy and there is no existing bill of work that the maintenance can be attached to, a new bill of work is created and scheduled in MEM server 108, which will send a copy of the new bill of work to SA server 111. At step 810, it is determined if SA server 111 is receiving the new bills of work from MEM server 108 and if SA server 111 is recording the proper data.

Once the new bill of work has been created and scheduled and the maintenance on the aircraft has been started, a maintenance action initiation is entered into MEM server 108, which will send a maintenance action initiation message to ELBg server 146 and ISDP server 110. At step 815, it is determined if ELBg server 146 is receiving the maintenance action initiation messages from MEM server 108 and if ELBg server 146 is recording the proper data. At step 820, it is determined if ISDP server 110 is receiving the maintenance action initiation messages from MEM server 108 and if ISDP server 110 is recording the proper data.

Once the maintenance tasks in the bill of work have been completed, a tasks completed action is entered into MEM server 108, which will send a tasks completed message to ELBg server 146 and ISDP server 110. At step 825, it is determined if ELBg server 146 is receiving the tasks completed messages from MEM server 108 and if ELBg server 146 is recording the proper data. At step 830, it is determined if ISDP server 110 is receiving the tasks completed messages from MEM server 108 and if ISDP server 110 is recording the proper data.

Once the tasks completed action has been entered into MEM server 108, the maintenance release is signed in MEM server 108, which sends a copy of the maintenance release to ELBg server 146 and SA server 111. At step 835, it is determined if ELBg server 146 is receiving the signed maintenance releases from MEM server 108 and if ELBg server 146 is recording the proper data. At step 840, it is determined if SA server 111 is receiving the signed maintenance releases from MEM server 108 and if SA server 111 is recording the proper data.

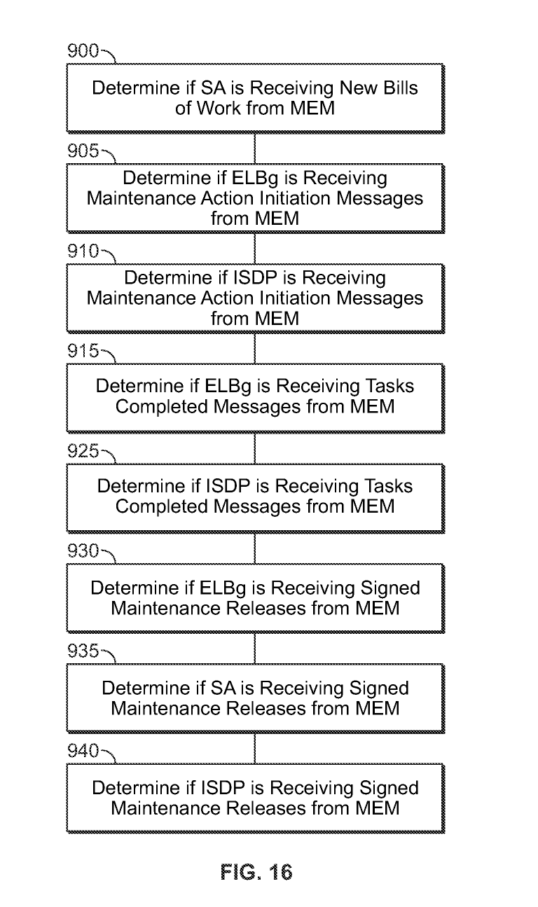

Referring to FIG. 16, exemplary steps taken to test the communications and data transmission between the internal systems of MSP 34 during routine maintenance procedures (step 230 above) are shown. In one example, when an aircraft is scheduled for routine maintenance and no bill of work has been created, a new bill of work is created and scheduled in MEM server 108, which will send a copy of the new bill of work to SA server 111. At step 900, it is determined if SA server 111 is receiving the new bills of work from MEM server 108 and if SA server 111 is recording the proper data.

Once a bill of work has been created and scheduled, whether new or existing, and the maintenance on the aircraft has been started, a maintenance action initiation is entered into MEM server 108, which will send a maintenance action initiation message to ELBg server 146 and ISDP server 110. At step 905, it is determined if ELBg server 146 is receiving the maintenance action initiation messages from MEM server 108 and if ELBg server 146 is recording the proper data. At step 910, it is determined if ISDP server 110 is receiving the maintenance action initiation messages from MEM server 108 and if ISDP server 110 is recording the proper data.

Once the maintenance tasks in the bill of work have been completed, a tasks completed action is entered into MEM server 108, which will send a tasks completed message to ELBg server 146 and ISDP server 110. At step 915, it is determined if ELBg server 146 is receiving the tasks completed messages from MEM server 108 and if ELBg server 146 is recording the proper data. At step 925, it is determined if ISDP server 110 is receiving the tasks completed messages from MEM server 108 and if ISDP server 110 is recording the proper data.

Once the tasks completed action has been entered into MEM server 108, the maintenance release is signed in MEM server 108, which sends a copy of the maintenance release to ELBg server 146, SA server 111, and ISDP server 110. At step 930, it is determined if ELBg server 146 is receiving the signed maintenance releases from MEM server 108 and if ELBg server 146 is recording the proper data. At step 935, it is determined if SA server 111 is receiving the signed maintenance releases from MEM server 108 and if SA server 111 is recording the proper data. At step 940, it is determined if ISDP server 110 is receiving the signed maintenance releases from MEM server 108 and if ISDP server 110 is recording the proper data.

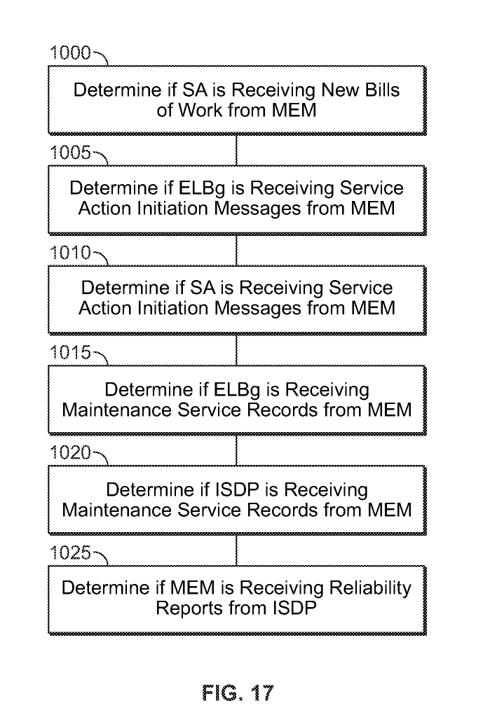

Referring to FIG. 17, exemplary steps taken to test the communications and data transmission between the internal systems of MSP 34 during service procedures (step 235 above) are shown. In one example, when an aircraft is scheduled for service and no bill of work has been created, a new bill of work is created and scheduled in MEM server 108, which will send a copy of the new bill of work to SA server 111. At step 1000, it is determined if SA server 111 is receiving the new bills of work from MEM server 108 and if SA server 111 is recording the proper data.

Once a bill of work has been created and scheduled, whether new or existing, and the service on the aircraft has been started, a service action initiation is entered into MEM server 108, which will send a service action initiation message to ELBg server 146 and SA server 111. At step 1005, it is determined if ELBg server 146 is receiving the service action initiation messages from MEM server 108 and if ELBg server 146 is recording the proper data. At step 1010, it is determined if SA server 111 is receiving the service action initiation messages from MEM server 108 and if SA server 111 is recording the proper data.

Once the service tasks in the bill of work have been completed, a maintenance service record is entered into MEM server 108, which sends a copy of the maintenance service record to ELBg server 146 and ISDP server 110. At step 1015, it is determined if ELBg server 146 is receiving the maintenance service records from MEM server 108 and if ELBg server 146 is recording the proper data. At step 1020, it is determined if ISDP server 110 is receiving the maintenance service records from MEM server 108 and if ISDP server 110 is recording the proper data.

Once the maintenance service records have been created, a reliability analysis is performed to analyze the data sent to ISDP server 110 to existing data in ISDP server 110 to ascertain anomalies, for example frequency of failure by airplane, number of airplanes in a fleet, etc. Based on the results of the reliability analysis, a reliability report is generated in ISDP server 110, which sends a copy of the reliability report to MEM server 108. At step 1025, it is determined if MEM server 108 is receiving the reliability reports from ISDP server 110 and if ISDP server 110 is recording the proper data.

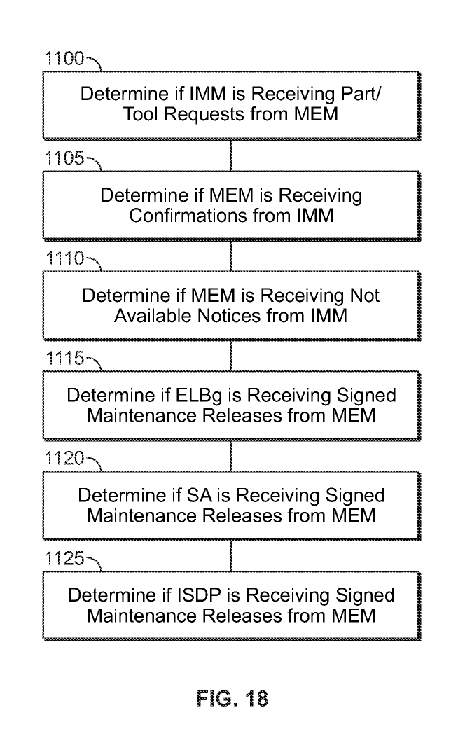

Referring to FIG. 18, exemplary steps taken to test communications and data transmission between the internal systems of MSP 34 during material/tool request procedures (step 240 above) are shown. For example, during an evaluation of the forecast for maintenance tasks coming due, a new bill of work may be created or tasks may be added to an existing bill of work. If a new bill of work is created or additional tasks added to an existing bill of work, part/tool requests are generated in MEM server 108, which sends a copy of the part/tool request to IMM server 118. At step 1100, it is determined if IMM server 118 is receiving the part/tool requests from MEM server 108 and if IMM server 118 is recording the proper data.

Once the part/tool request is received by IMM server 118, a decision is made if the part/tool requested is available on the date, at the time, and at the location requested. If the part/tool is available, IMM server 118 sends a confirmation that the part/tool is available to MEM server 108. At step 1105, it is determined if MEM server 118 is receiving the confirmations from IMM server 118 and if MEM server 108 is recording the proper data. If the part/tool is not available, IMM server 118 sends a not available notice to MEM server 108, at which time a plan must be developed and implemented regarding the bill of work. At step 1110, it is determined if MEM server 118 is receiving the not available notices from IMM server 118 and if MEM server 108 is recording the proper data.

Once the tasks in the bill of work have been completed, a maintenance release is signed in MEM server 108, which sends a copy of the maintenance release to ELBg server 146, SA server 111, and ISDP server 110. At step 1115, it is determined if ELBg server 146 is receiving the signed maintenance releases from MEM server 108 and if ELBg server 146 is recording the proper data. At step 1120, it is determined if SA server 111 is receiving the signed maintenance releases from MEM server 108 and if SA server 111 is recording the proper data. At step 1125, it is determined if ISDP server 110 is receiving the signed maintenance releases from MEM server 108 and if ISDP server 110 is recording the proper data.

It will be understood that the tasks of determining communications and receipt of information in all of the above steps could be performed in a variety of ways which are well known to those skilled in the art. In addition, the above tasks of determining that the information is recorded properly can also be performed in a variety of ways. For example, actual data that was sent from one system can be obtained and compared to and checked against the data recorded in the receiving system. In addition, test data having known values could be sent from one system and then checked against the data recorded in the receiving system to verify that the recorded data is correct.

The foregoing description of examples of the invention have been presented for purposes of illustration and description, and are not intended to be exhaustive or to limit the invention to the precise forms disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A method for managing the maintenance and materials for an aircraft fleet comprising:
operating a network of computing devices including a central integrated maintenance and material services (IMMS) center having a maintenance and engineering management (MEM) server configured to control a peripheral group of servers including one or more of a ground based electronic log book and aircraft health and maintenance (ELB and AHM) server, an in service data program (ISDP) server, a situational awareness (SA) server and an integrated material management (IMM) server, where each of the maintenance and engineering management server and the peripheral group of servers have at least one processor and at least one memory;
executing with the at least one processor, instructions stored in the at least one memory causing the maintenance and engineering management server and the peripheral group of servers to perform the process of,
collecting aircraft on-board systems data from on-board data systems, where said aircraft on-board systems data is representative of one or more of on-board physical faults, parts, and flight information for a plurality of aircraft and receiving and centrally storing the aircraft on-board systems data at the at least one memory,
submitting a plurality of parts requests from the IMMS center through the IMM to a plurality of part supplier computing systems for parts to service the plurality of aircraft using the collected aircraft on-board systems data,
submitting a plurality of maintenance requests from the MEM server to a plurality of maintenance repair and overhaul (MRO) computing systems for maintenance using the collected aircraft on-board systems data, and
testing communication and data transmissions between the MEM and one or more of the ELB and AHM server, the SA sever, the ISDP server and the IMM server to verify correct transmissions; and
recording the communication and data transmission tests.

2. The method as recited in claim 1, for managing the maintenance and materials for an aircraft fleet, where testing communication and data transmissions includes determining if one or more of,
the ISDP server is receiving aircraft events data from the MEM server,
the ISDP server is receiving schedule maintenance data records from the MEM server,
the ISDP server is receiving landings data records from the MEM server,
the ISDP server is receiving LRU removals data records from the MEM server,
the ISDP server is receiving fault data records from the MEM server,
the ISDP server is receiving component shop findings data records from the MEM server,
the ISDP server is receiving scheduled maintenance data records from the MEM server,
the ISDP server is receiving service bulletin records from the MEM server, and
the ISDP server is receiving aircraft status change records from the MEM server.

3. The method as recited in claim 1, for managing the maintenance and materials for an aircraft fleet, where testing communication and data transmissions includes determining if one or more of,
the IMM server is receiving cancellation requests from the MEM server,
the MEM server is receiving confirmation of the cancellation requests from the IMM server,
the IMM server is receiving updated requests from the MEM server, and
the MEM server is receiving non-availability notices from the IMM server.

4. The method as recited in claim 1, for managing the maintenance and materials for an aircraft fleet, where testing communication and data transmissions includes determining if one or more of,
the SA server is receiving maintenance schedule events records from the MEM server,
the SA server is receiving maintenance alert records from the MEM server,
the SA server is receiving data records from the MEM server,
the SA server is receiving bills of work from the MEM server, the SA server is receiving bill of work signed records from the MEM server,
the SA server is receiving signed maintenance release records from the MEM server, and
the SA server is receiving airplane fault records from the MEM server.

5. The method as recited in claim 1, for managing the maintenance and materials for an aircraft fleet, where testing communication and data transmissions is performed by comparing the communication and data transmissions with stored data.

6. The method as recited in claim 1, for managing the maintenance and materials for an aircraft fleet, where testing communication and data transmissions is performed by simulating the network of computing devices thereby simulating the communication and data transmissions and monitoring the communications and data transmissions for accuracy.

7. The method as recited in claim 1, for managing the maintenance and materials for an aircraft fleet, where the process further includes,
collecting airline operational data from a plurality of airline operator computing systems and receiving and centrally storing the operational data at the central maintenance and engineering server, and where submitting a plurality of maintenance requests and submitting a plurality of parts requests includes using the collected airline operational data.
